(19) United States
(12) Patent Application Publication
(10) Pub. No.: US 2014/0285687 A1
(43) Pub. Date: Sep. 25, 2014

(54) IMAGE PROCESSING APPARATUS, METHOD FOR CONTROLLING IMAGE PROCESSING APPARATUS AND STORAGE MEDIUM

(71) Applicant: CANON KABUSHIKI KAISHA, Tokyo (JP)

(72) Inventor: Naoko Yamamoto, Yokohama-shi (JP)

(21) Appl. No.: 14/197,754

(22) Filed: Mar. 5, 2014

(30) Foreign Application Priority Data
Mar. 19, 2013 (JP) 2013-057302

(51) Int. Cl. H04N 5/907

(52) U.S. Cl. CPC H04N 5/907
USPC 348/231.99

(57) ABSTRACT

An image processing apparatus comprising: a storage unit configured to store user information of an imaging apparatus, image information containing an image or images captured by the imaging apparatus, and operation information of the imaging apparatus during image capture, in association with each other; an obtaining unit configured to obtain operation information corresponding to user information of a first imaging apparatus when receiving the user information of the first imaging apparatus; an analysis unit configured to analyze at least one time segment based on the operation information; and an extraction unit configured to extract image information corresponding to the at least one time segment from image information of an imaging apparatus or apparatuses other than the first imaging apparatus.

### BACKGROUND OF THE INVENTION

1. Field of the Invention

The present invention relates to image processing apparatuses, methods for controlling an image processing apparatus, and storage medium.

2. Description of the Related Art

The household penetration of digital cameras has increased in recent years, and therefore, there are increasing occasions when people capture digital images in events, such as a sports day etc.

In an event in which a relatively limited group of people take part, such as particularly a sports day etc., a participant may want images captured by another participant or may want to give another participant images captured by himself or herself. For example, a participant may want images of his or her child captured by another participant, or may want to give good images of another participant's child captured by himself or herself. In such a case, a participant may exchange images with another participant if they know each other (i.e., if you knows another participant who has images which you wants or if you knows the family of a child who is in images which you wants to give, you may receive or give the images from or to them). However, if they do not know each other, they cannot exchange images. It is not even easy for a participant to find out whether or not any other participant has an image which he or she would want.

To meet such a demand, there has in recent years been a technique of posting a user's images on a sharing site etc. via the Internet, thereby allowing the images to be shared with others. In order to share images with a large number of unspecified users using the sharing site, a specific sharing area is determined for an individual event, and users are given information about the sharing area and a right to access the sharing area. The users having the access right are permitted to upload, browse, and download images using the sharing site (see, for example, Flickr (http://www.flickr.com/)).

However, when a large quantity of images is shared on the sharing site, it may take a lot of time and effort for the user to browse all images. Therefore, the user is allowed to narrow image search criteria by himself or herself by using a technique of managing and searching captured images in association with conditions under which the images were captured, the feature amounts of the images, the ratings and frequencies at which the images have been evaluated and used by viewers (see Japanese Patent Laid-Open Nos. 11-215451 and 2007-274195). Captured images on the sharing site may be classified using the image information associated with the images.

There is a known technique of enabling a user who took part in an event and took images using his or her own camera, and failed to capture an image during a part of the event, to easily obtain images capture by others who took part in the same event (see Japanese Patent Laid-Open No. 2010-246090). In this technique, initially, a plurality of images captured by the user's camera are sorted according to the time they were captured. A period of time during which the user did not capture an image is calculated. Of images which were captured by other users' cameras, any image that was captured during the time period during which the user did not capture an image, is extracted. In addition, of the images captured by the user's camera, any image that is associated with the same keyword, capture time, and subject information, is extracted.

By using the techniques of Japanese Patent Laid-Open Nos. 11-215451 and 2007-274195 supra, only images that meet the search criteria specified by the user can be displayed, for example. However, when only the image information associated with images is available, it takes a lot of time and effort to search for images desired by the user, and also, images which are not expected by the user are often included in the search results. For example, it takes a lot of time and effort for the user to specify a period of time during which the user did not capture an image in a sports day in order to search for images which were captured during that period of time.

By using the technique of Japanese Patent Laid-Open No. 2010-246090 supra, a period of time during which the user did not capture an image is automatically detected, and only images which were captured during that period of time can be searched for and presented. However, not only images which the user wants to view but also images which have nothing to do with the user may be presented. For example, images which were captured during a period of time during which the user deliberately did not capture an image (e.g., in a sports day, a parent of a third-grade pupil did not capture an image in an event in which only first-grade pupils took part, etc.) are also extracted, and therefore, images which are not related to the user may be extracted.

### SUMMARY OF THE INVENTION

According to one aspect of the present invention, there is provided an image processing apparatus comprising: a storage unit configured to store user information of an imaging apparatus, image information containing an image or images captured by the imaging apparatus, and operation information of the imaging apparatus during image capture, in association with each other; an obtaining unit configured to obtain operation information corresponding to user information of a first imaging apparatus when receiving the user information of the first imaging apparatus; an analysis unit configured to analyze at least one time segment based on the operation information; and an extraction unit configured to extract image information corresponding to the at least one time segment from image information of an imaging apparatus or apparatuses other than the first imaging apparatus.

Further features of the present invention will be apparent from the following description of exemplary embodiments with reference to the attached drawings.

### BRIEF DESCRIPTION OF THE DRAWINGS

FIG. 1 is a diagram showing a functional configuration of a captured image sharing system according to a first embodiment.

FIG. 2 is a diagram showing a hardware configuration of an imaging apparatus according to the first embodiment.

FIG. 3 is a flowchart showing steps of an entire process of the imaging apparatus of the first embodiment.

FIG. 4 is a flowchart showing steps of a capture operation information obtaining process in the imaging apparatus of the first embodiment.

FIG. 5 is a diagram showing an example of capture operation information according to the first embodiment.

FIG. 6 is a flowchart showing steps of an entire process of an image sharing apparatus according to the first embodiment.

FIGS. 7A and 7B are diagrams showing communication sequences according to the first embodiment.

FIG. 8 is a flowchart showing steps of an image list producing process in the image sharing apparatus of the first embodiment.

FIG. 9 is a flowchart showing steps of a capture operation information analyzing process in the image sharing apparatus of the first embodiment.

FIG. 10 is a diagram for describing the capture operation information analyzing process which is performed only based on capture operation information according to the first embodiment.

FIG. 11 is a diagram for describing the capture operation information analyzing process which is performed based on information about stored images of a user according to the first embodiment.

FIG. 12 is a flowchart showing steps of an entire process of an image sharing apparatus according to a second embodiment.

FIG. 13 is a flowchart showing steps of a related user estimating process according to the second embodiment.

FIG. 14 is a diagram for describing the related user estimating process which is performed based on operation information according to the second embodiment.

FIG. 15 is a flowchart showing steps of an image list producing process which is performed based on estimation of a related user according to the second embodiment.

FIG. 16 is a diagram for describing a process of obtaining information of shared images of a related user based on operation information according to the second embodiment.

FIG. 17 is a diagram for describing the related user estimating process which is performed based on uploaded image information according to the second embodiment.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

In embodiments described below, an image sharing apparatus is provided which enables a user to efficiently browse only one or ones that are related to the user and particularly that the user wanted to capture, of shared images which were captured by others.

### First Embodiment

In this embodiment, an example technique will be described which is used to narrow down images on a sharing site based on camera operation information which is obtained when a user captures the images (the camera operation information is also referred to as “capture operation information”) to present a plurality of images. Specifically, an example will be described in which when a sports day is staged by an elementary school, then if a plurality of parents of pupils only upload images captured by themselves to a sharing site, one or ones related to one parent of shared images captured by other parents are presented to that parent.

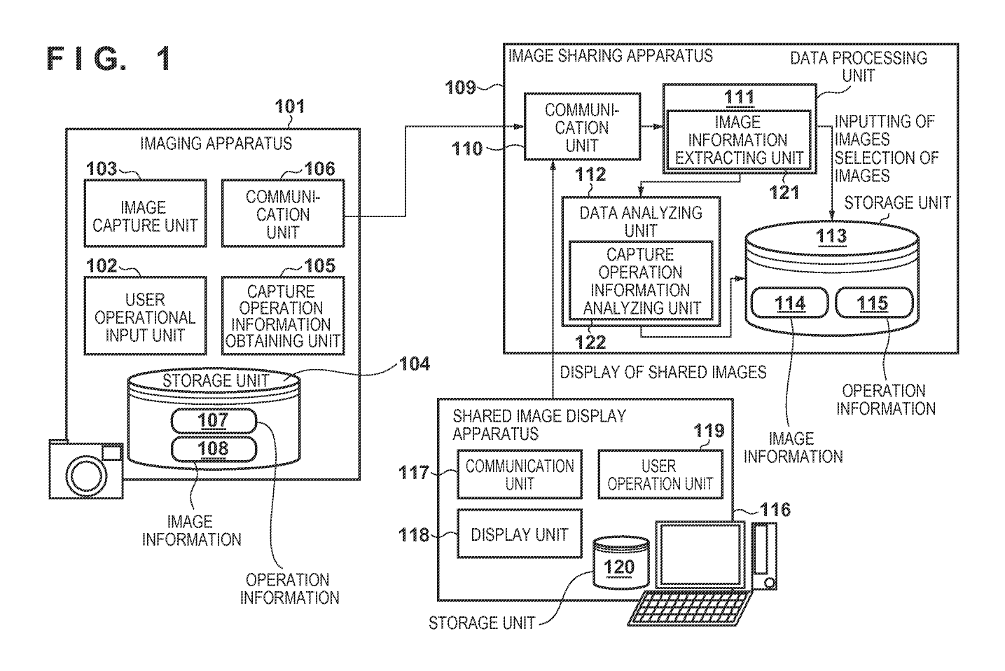

FIG. 1 shows an example functional configuration of a captured image sharing system according to this embodiment.

The captured image sharing system includes at least one imaging apparatus 101, an image sharing apparatus 109, and a shared image display apparatus 116.

(Configuration of Imaging Apparatus 101)

The imaging apparatus 101 includes a user operational input unit 102, an image capture unit 103, a storage unit 104, a capture operation information obtaining unit 105, and a communication unit 106.

The imaging apparatus 101 captures an image by instructing the image capture unit 103 to capture the image according to an operation which is input by the user via the user operational input unit 102. The user operational input unit 102 receives the user's operational inputs, such as an instruction to capture an image, an instruction to display an image, etc. Of these operation information items, capture operation information is obtained by the capture operation information obtaining unit 105.

The image capture unit 103 has the functionality of a digital camera including a lens unit, a drive unit, various sensor units, etc. The storage unit 104 stores image information 108 which contains an image captured by the image capture unit 103 and attribute information of the image, and operation information 107 which is obtained by the capture operation information obtaining unit 105.

The capture operation information obtaining unit 105 obtains operation information when the user captures an image. The communication unit 106 transmits the image information 108 containing an image captured by the image capture unit 103 and attribute information of the image, and the operation information 107 obtained by the capture operation information obtaining unit 105, as shared data, to the image sharing apparatus 109.

The operation information 107 is capture operation information which is obtained by the capture operation information obtaining unit 105, and indicates an operation performed on the apparatus by the user. The capture operation information means operation information relating to image capture, and may be information about an operation which is performed prior to actual image capture. For example, the capture operation information may contain an operation such as pressing down of the shutter button, turning on and off of the imaging apparatus, etc., and the time of occurrence of the operation. Alternatively, the capture operation information may contain an operation such as keeping the imaging apparatus on, pressing halfway down of the shutter button for automatic focusing on a subject, etc., and the duration of the operation. The capture operation information may also contain information of various sensors included in the camera, that are used to record details of the user's operation, such as the time during which the imaging apparatus continues to be held in the horizontal position, the time during which the user continues to look into the viewfinder, etc.

(Configuration of Image Sharing Apparatus 109)

The image sharing apparatus 109 includes a communication unit 110, a data processing unit 111, a data analyzing unit 112, and a storage unit 113. The image sharing apparatus 109 has a function of enabling users to share images, such as captured images etc. Image information 114 and capture operation information 115 of captured images transmitted from a plurality of the imaging apparatuses 101 are stored. Captured images are shared in response to a request from a plurality of the shared image display apparatuses 116.

The communication unit 110 communicates with other apparatuses etc. The communication unit 110 allows for reception of image information and capture operation information transmitted from the imaging apparatus 101, communication with the shared image display apparatus 116, and data sharing.

The data processing unit 111 saves data transmitted from other apparatuses to the storage unit 113, and extracts data from the storage unit 113 in response to a request from other apparatuses. In particular, when an image is saved, the data processing unit 111 also extracts information for managing the image in the storage unit 113. Examples of the information for managing an image in the storage unit 113 include the date and time of image capture, the place of image capture, the identification information of a capture apparatus, etc., which are attached to the image, user information of the sender of the captured image, the identifier of the sender's camera, etc. Images handled by the image sharing apparatus 109 have been captured by imaging apparatuses possessed by a plurality of users. Therefore, the data processing unit 111 also has a function of managing users who have captured images and identifying the individual users.

The data processing unit 111 also includes an image information extracting unit 121. Specifically, when an image is extracted, image information is extracted by the image information extracting unit 121 from the storage unit 113 based on the management information of the image.

The data analyzing unit 112 analyzes information of various data items stored in the storage unit 113. Specifically, the data processing unit 111, when instructed to produce a list of images according to a request from the shared image display apparatus 116, instructs the data analyzing unit 112 to analyze capture operation information. Thereafter, a capture operation information analyzing unit 122 included in the data analyzing unit 112 analyzes the operation information 115 of each user stored in the storage unit 113 in order to find out a portion which is of importance or interest to the user. The image information extracting unit 121 included in the data processing unit 111 also extracts images corresponding to the portion of importance or interest found by the capture operation information analyzing unit 122 to produce, for the user, a list of image information 114 which can be shared.

The storage unit 113 stores various items of data etc. Specifically, the storage unit 113 stores the image information 114 and the capture operation information 115. For the stored image information 114 of each captured image, the storage unit 113 also simultaneously stores management information indicating whether or not the image information 114 is permitted to be shared or published, for each user and for each captured subject or event, for example. The storage unit 113 has the functionality of a general database. In the storage unit 113, each piece of stored data is assigned an ID, and is managed and extracted based on the specific data ID.

The image information 114 indicates images captured by other apparatuses, such as the imaging apparatus 101 etc., and attribute information of the images. The operation information 115 indicates operations during image capture of other apparatuses, such as the imaging apparatus 101 etc.

(Configuration of Shared Image Display Apparatus 116)

The shared image display apparatus 116 includes a communication unit 117, a display unit 118, a user operation unit 119, and a storage unit 120.

The shared image display apparatus 116 can be used to use and check images. Specifically, the shared image display apparatus 116 displays images stored in the image sharing apparatus 109 to the user, thereby enabling the user to check and browse the images. The shared image display apparatus 116 may be hardware such as a digital camera, a mobile telephone, a personal computer, etc., or alternatively, software such as a computer program etc. provided in such hardware. The communication unit 117 communicates with another apparatuses etc. Specifically, the communication unit 117 communicates with the shared image display apparatus 116 so that data can be shared.

The display unit 118 can display various items of data to the user. Here, the display unit 118 receives images extracted from the image sharing apparatus 109, produces an image to be displayed on the screen, and displays the screen image. The user operation unit 119 receives the user's operations. The storage unit 120 stores browsed images, user information needed to check shared images, etc., which are saved thereto according to the user's instruction.

Here, in order to facilitate processes, such as saving of images, browsing of images, etc., in association with the image sharing apparatus 109, the imaging apparatus 101 and the shared image display apparatus 116 desirably possess information (account information) about a user who captures images or a user who uses images, the subjects of captured images, etc.

It is, for example, assumed that, in a sports day which takes place in an elementary school, images captured by the imaging apparatus 101 are shared in the image sharing apparatus 109 and browsed using the shared image display apparatuses 116. In this case, the account information of each of pupils' parents who capture images is previously stored in the storage unit 104 of his or her own imaging apparatus 101. On or before the sports day, information for identifying event information (sports day) is distributed to the parents (users) involved, by the school which provides a means for sharing images. Each user saves this information to the storage unit 104 of the imaging apparatus 101 and the storage unit 120 of the shared image display apparatus 116.

In this embodiment, when image information is uploaded to the shared image display apparatus 116, the user information is simultaneously transmitted, and the image information and the user information are saved in association with each other.

The event information may be provided to each apparatus using the communication unit 106 of the imaging apparatus 101 or the communication unit 117 of the shared image display apparatus 116, or alternatively, via an external storage apparatus such as a memory card etc.

The information for identifying an event may be the URL of a sharing site or image attribute information attached to images.

If the event information is the URL of a sharing site, a user can specify the image sharing site using the URL, and therefore, can explicitly separate a sharing range for other users who take part in the same event and share images from another sharing range for other general users.

In this embodiment, if the event information is image attribute information attached to images, shared images to be browsed by users need to be given the image attribute information (i.e., the image attribute information is attached to shared images), and images without the image attribute information are removed from the parent population of shared images. In other words, the sharing range of users is determined under conditions that images included in the range need to have the same image attribute information.

While, in this embodiment, the imaging apparatus 101 and the shared image display apparatus 116 are separated from each other, a single apparatus may have the functionality of both of the two apparatuses and may be able to allow the user to simultaneously capture images and browse shared images.

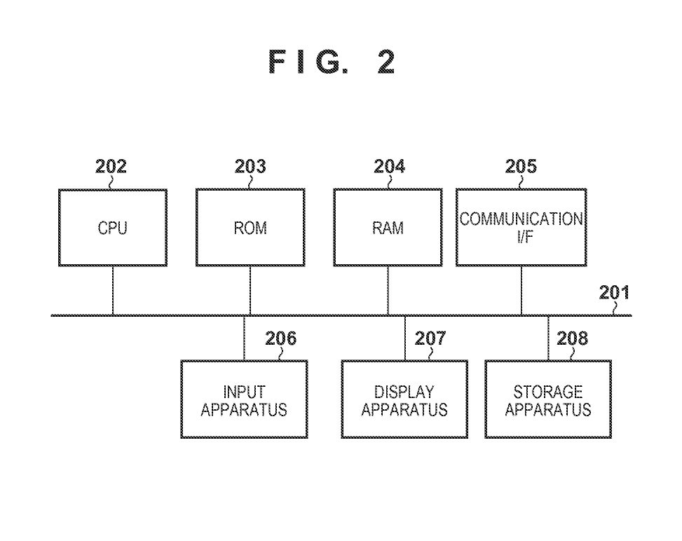

FIG. 2 is a block diagram showing an example hardware configuration of the imaging apparatus 101 of the first embodiment.

The imaging apparatus 101 includes a CPU 202, a ROM 203, a RAM 204, a communication interface 205, an input apparatus 206, a display apparatus 207, and a storage apparatus 208, which elements are connected together via a bus 201.

The CPU 202 controls the elements connected to the bus 201 to control an operation of the imaging apparatus 101. The ROM 203 stores a program for controlling an operation of the imaging apparatus 101. The RAM 204 is an area in which the program stored in the ROM 203 is executed.

The communication interface 205 has a function of communicating with an external apparatus. Specifically, the communication interface 205 may have a function of connecting to a wireless LAN or a GPS receiver which is used to connect to and transmit image data to the image sharing apparatus 109. The GPS receiver may be incorporated in the imaging apparatus 101.

The input apparatus 206 receives, for example, operations performed by the user on the imaging apparatus 101. The input apparatus 206 includes a shutter button for capturing an image, a button for changing image capture modes etc., a menu button for uploading images to a shared holder, etc. The display apparatus 207 displays images captured by the user to allow the user to check the images, and displays a menu etc. The storage apparatus 208 has a function of storing captured image files etc. Although not shown in FIG. 2, a flash memory for storing variable setting information etc. may be provided in addition to the ROM 203.

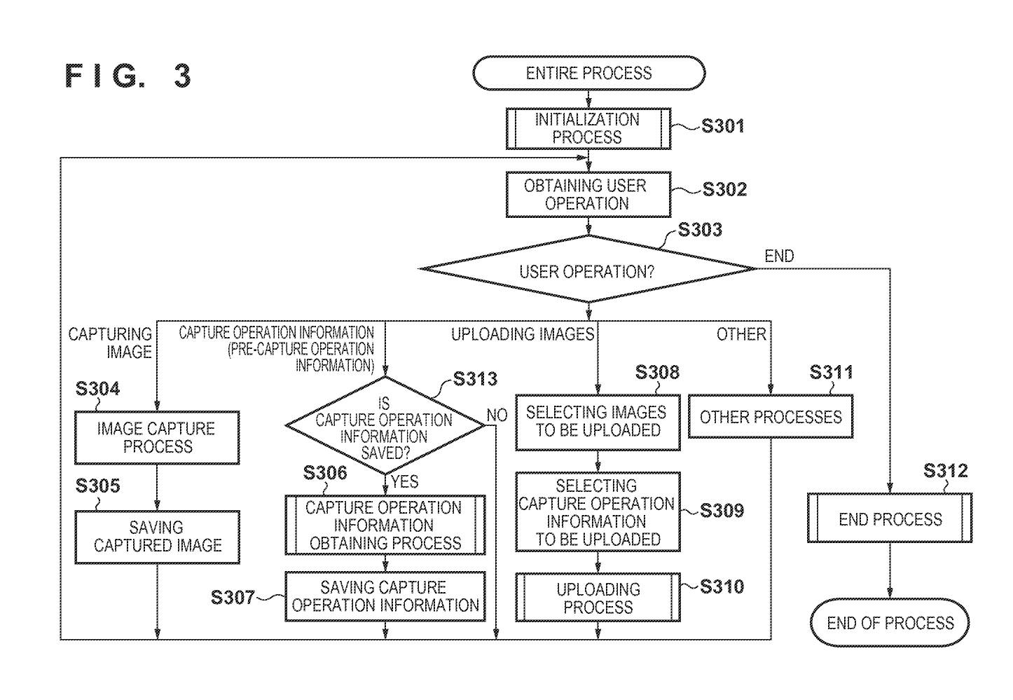

FIG. 3 is a flowchart showing steps of an entire process of the imaging apparatus 101 of the first embodiment.

When the imaging apparatus 101 is turned on or an image sharing start process is performed, the entire procedure begins. Here, in this embodiment, it is assumed that capture operation information is invariably saved, and control invariably proceeds to step S306 (“YES”) after a determination process of step S313.

In step S301, the imaging apparatus 101 performs an initialization process. Here, a preliminary process is performed in order to allow images which have been captured using the imaging apparatus 101 to be shared in the image sharing apparatus 109. As described above, the account information of a pupil's parent who will capture images and information about an event (sports day) in which the parent will capture images, are assumed to be previously stored in the storage unit 104 of the imaging apparatus 101.

In the initialization process of step S301, the imaging apparatus 101 extracts from the storage unit 104 the account information and the information about the event to be captured, and sets itself to easily communicate with the image sharing apparatus 109. Specifically, the imaging apparatus 101 sets itself to easily upload the image information 108 and the capture operation information 107. Here, the image information contains a captured image itself and attribute information about the captured image such as the time of capture etc. The imaging apparatus 101 also determines what information is saved as the capture operation information 107. This information is used in step S307 and following steps. In this embodiment, the time of pressing the shutter button down is saved as the capture operation information.

In step S302, the imaging apparatus 101 obtains the user's operation to the imaging apparatus 101.

In step S303, the imaging apparatus 101 determines what the user's operation obtained in step S302 is. Control proceeds to a step corresponding to the user's operation determined.

In this embodiment, it is assumed that a parent who captures images tries to capture images of his or her child who takes part in an event. The parent who captures images is now referred to as a “user A.”

The user A presses down the shutter button included in the input apparatus 206 in order to capture an image of his or her child. Based on the user's operation that is the pressing down of the shutter button, the imaging apparatus 101 determines that two operations have been performed by the user, and puts “capture operation information” and “image capture” into a user operation queue, and serially performs a capture operation information obtaining process of step S306 and an image capture process of step S304.

More specifically, in step S302, the data of the user's operations is sequentially extracted from the user operation queue. After the determination process of step S303 is performed, the capture operation information obtaining process of step S306 is performed. After the next determination process of step S303, control proceeds to the image capture process of step S304.

Note that, here, the determination process of step S303 and following processes are assumed to be serially performed. Alternatively, before a first process is ended, the next determination may be performed, and a second process may be performed in parallel with the first process. For example, the capture operation information obtaining process of step S306 may be initially performed, and after the end of this process, the image capture process of step S304 may be performed. Alternatively, the capture operation information obtaining process of step S306 and the image capture process of step S304 may be performed in parallel.

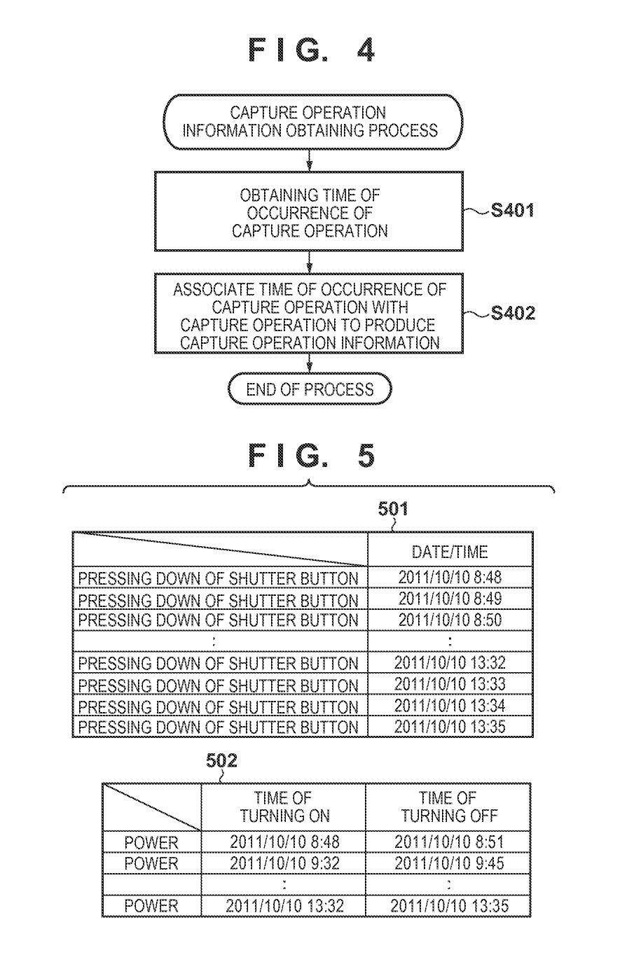

When the user A presses the shutter button down, events “capture operation information” and “image capture” are produced as the user's operations. In this embodiment, after the process of step S313, control invariably proceeds to the capture operation information obtaining process of step S306 (the result of step S313 is positive (“YES”)). The flow of this process will be described in detail with reference to a flowchart shown in FIG. 4.

FIG. 4 is a flowchart showing steps of the capture operation information obtaining process in the imaging apparatus 101 of the first embodiment.

In step S401, the imaging apparatus 101 obtains the time of occurrence of a capture operation.

In step S402, the imaging apparatus 101 saves the capture operation and the time of occurrence of the capture operation obtained in step S401, as capture operation information, in association with each other. In this embodiment, the combination of “the pressing down of the shutter button” as a capture operation and the time of “the pressing down of the shutter button” are associated with each other to form the capture operation information 107. In other words, the combination of a capture operation (=“the pressing down of the shutter button”) and the time of occurrence of the pressing down of the shutter button is defined as the capture operation information 107.

Referring back to FIG. 3, in step S307, the imaging apparatus 101 saves the capture operation information 107 thus obtained in step S306 to the storage unit 104. An example of the stored capture operation information is shown in FIG. 5.

FIG. 5 is a diagram showing an example of the capture operation information of the first embodiment. For example, when, as described in this embodiment, the combination of “the pressing down of the shutter button” as a capture operation and the time of “the pressing down of the shutter button,” which are associated with each other, is saved as capture operation information, the capture operation information is stored as shown in Table 501. In this embodiment, the capture operation information shown in Table 501 is handled. The present invention is not limited to this. One capture operation may be stored in association with two or more times. For example, when information about power supply is saved as capture operation information, a piece of information about “power supply” may be stored in association with two or more times, e.g., the time of turning on and the time of turning off, as shown in Table 502.

Here, as described in this embodiment, capture operation information may be invariably obtained and saved. Alternatively, the user may determine whether or not to save capture operation information. The setting indicating whether or not capture operation information is to be saved is stored in the imaging apparatus 101 by the initialization process of step S301. The result of the process of step S313 of determining whether or not capture operation information is to be saved is changed, depending on the setting indicating whether or not capture operation information is to be saved.

Note that not only the user's setting is read by the initialization process of step S301, but also another process of step S311 may be performed to receive the user's request to change the setting. For example, if the user captures, during a part of the sports day, private images which are not intended to be shared, the user may set the imaging apparatus 101 to intentionally not save capture operation information during the part of the sports day.

When the capture operation information saving process of step S307 is ended, control returns to step S302. Thereafter, in step S302, the imaging apparatus 101 obtains “image capture” as the user's operation, and control proceeds to the determination process of step S303 and then to S304.

In step S304, the imaging apparatus 101 instructs the image capture unit 103 to capture an image.

In step S305, the imaging apparatus 101 saves the captured image information 108 to the storage unit 104. While capturing images in a sports day, the user A can successively check the captured images and upload good ones thereof to the shared holder in order to use the images after returning home. To upload the images, the user A instructs the imaging apparatus 101 to upload the images, using the input apparatus 206. Note that the operation of instructing the imaging apparatus 101 to upload images may be selected from a menu displayed on the display apparatus 207 or may be implemented by a mechanical button.

When the user A instructs the imaging apparatus 101 to upload images, in step S302 the imaging apparatus 101 obtains the “image upload” operation, and control proceeds to the determination process of step S303 and then to step S308. In step S308, the imaging apparatus 101 selects an image(s) to be uploaded. Here, the imaging apparatus 101 displays a list of captured images on the display apparatus 207, and may allow the user A to select an image to be loaded or may select only an image most recently captured by the user A as an image to be uploaded. Alternatively, for example, the user A may be allowed to designate an image as one to be uploaded while capturing the image, thereby selecting the image as an image to be loaded.

In step S309, the imaging apparatus 101 selects capture operation information to be uploaded. In this embodiment, all capture operation information stored is assumed to be uploaded. Capture operation information which has been saved after the previous uploading and until the present time is obtained from the storage unit 104. Here, capture operation information to be uploaded may be selected by the user. For example, a period of time during which images to be uploaded were captured may be specified. For example, a period of time during which the user tried capturing before the beginning of a sports day may be excluded.

In step S310, the imaging apparatus 101 uploads the images to be uploaded which have been selected in steps S308 and S309, and the capture operation information thereof, to the image sharing apparatus 109, with which the imaging apparatus 101 can communicate via a network. Thus, the user A saves captured images and capture operation information thereof, uploads captured images, etc., using the imaging apparatus 101.

When the user A instructs the imaging apparatus 101 to perform another process such as changing of settings etc., in step S302 “OTHER” is obtained as the user's operation, and thereafter, control proceeds to the determination process of step S303 and then to S311. In step S311, the imaging apparatus 101 performs another process.

If the imaging apparatus is off when image capture is not performed during a lunch break in a sports day, after the end of a sports day, etc., in step S302 “END” is obtained as the user's operation, and thereafter, control proceeds to the determination process of step S303 and then to step S312, in which an end process is performed. Here, if an image to be uploaded or capture operation information has not yet been transmitted and is left, an uploading process may be performed during the end process.

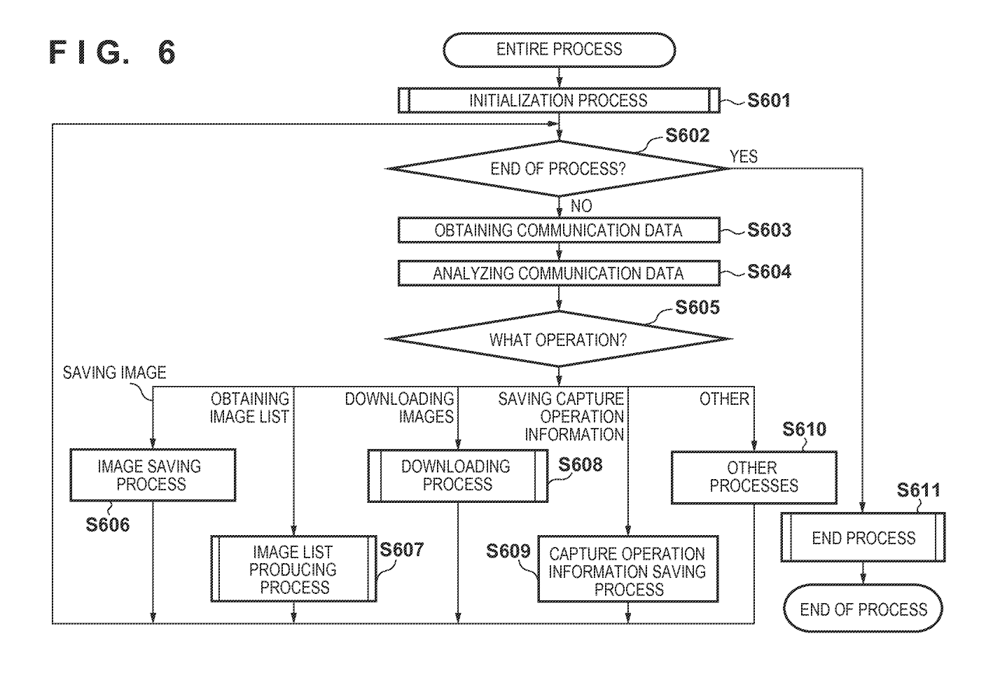

In the foregoing, the process of the imaging apparatus 101 has been described. A process of the image sharing apparatus 109 will now be described in detail. FIG. 6 is a flowchart showing steps of an entire process of the image sharing apparatus 109 of the first embodiment.

When the image sharing apparatus 109 is actuated, in step S601 an initialization process is performed. Here, when actuated, the image sharing apparatus 109 initializes each processing unit, loads information for managing users who are permitted to access, etc. Steps following step S601 are repeatedly performed until the image sharing apparatus 109 is instructed to perform an end process, i.e., the result of the determination of step S602 causes control to proceed to the end process of step S611.

In step S603, the image sharing apparatus 109 obtains communication data from another apparatus on a network.

In step S604, the image sharing apparatus 109 analyzes the communication data obtained in step S603 to obtain data of a user's operation. Data transmitted from another apparatus is assumed to contain an instruction to the image sharing apparatus 109 to perform a predetermined process. The data may also contain data indicating an image etc. in addition to the instruction. In step S605, the image sharing apparatus 109 determines what the user's operation obtained in step S604 is. Control proceeds to a process corresponding to the user's operation determined.

If the result of the analysis of the user's operation based on the transmitted data indicates an image saving process which is requested by the imaging apparatus 101, control proceeds to the determination process of step S605 and then to step S606.

In step S606, the image sharing apparatus 109 performs the image saving process. In step S606, the data processing unit 111 obtains image data to be saved, and saves the image data to the storage unit 113. The image data to be saved may be contained in the transmitted data, or alternatively, the image sharing apparatus 109 may separately request the imaging apparatus 101 to transmit the image data. Here, the data processing unit 111 assigns, to the image to be saved, an identification number (ID) for identifying the image, and saves the image to be saved to the storage unit 113 in association with the capture operation information of the image itself, information about the imaging apparatus 101 which is the sender, and information about the sender user.

If the result of the analysis of the user's operation based on the transmitted data indicates an image downloading process which is requested by the shared image display apparatus 116, control proceeds to the determination process of step S605 and then to step S608.

In step S608, the image sharing apparatus 109 performs the image download process. In step S608, the data processing unit 111 obtains information (an identification number (ID) for identifying an image etc.) about image data to be downloaded by the user, obtains the image to be downloaded from the storage unit 113, and transmits the image to be downloaded to the shared image display apparatus 116.

If the result of the analysis of the user's operation based on the transmitted data indicates obtaining an image list producing process which is requested by the shared image display apparatus 116, control proceeds to the determination process of step S605 and then to step S607.

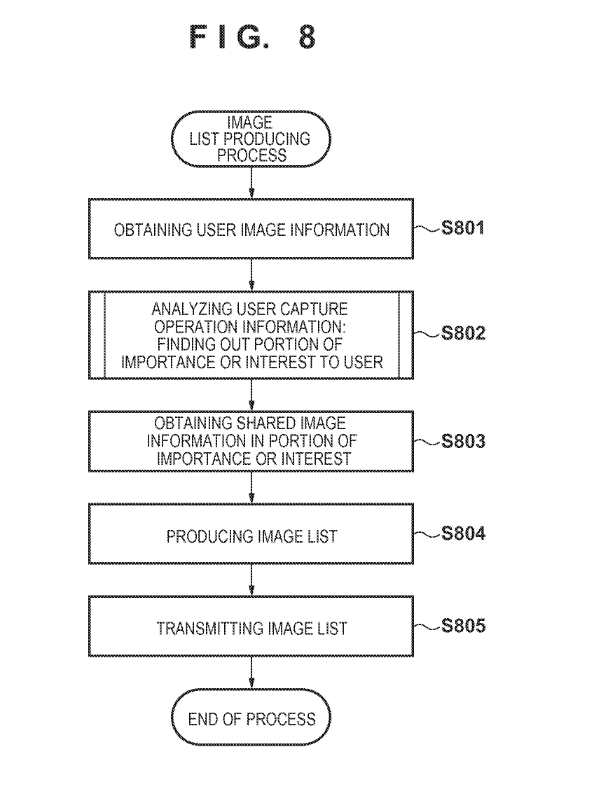

In step S607, the image sharing apparatus 109 performs the image list producing process. The data analyzing unit 112 performs this process in response to a request from the data processing unit 111. The process will be described in detail below with reference to FIG. 8.

If the result of the analysis of the user's operation based on the transmitted data indicates a capture operation information saving process which is requested by the imaging apparatus 101, control proceeds to the determination process of step S605 and then to step S609.

In step S609, the image sharing apparatus 109 performs the capture operation information saving process. In step S609, the data processing unit 111 obtains capture operation information to be saved, and saves the capture operation information to the storage unit 113. The data of the capture operation information to be saved may be contained in the transmitted data. Alternatively, the image sharing apparatus 109 may separately request the imaging apparatus 101 to transmit the data of the capture operation information. Here, the data processing unit 111 assigns an identification number (ID) for identification to the capture operation information to be saved, and saves the capture operation information to be saved to the storage unit 113 in association with information about the imaging apparatus 101 which is the sender and information about the sender user.

If the result of the analysis of the user's operation based on the transmitted data indicates another process which is requested by another apparatus on a network, control proceeds to the determination process of step S605 and then to step S610.

In step S610, the image sharing apparatus 109 causes the data processing unit 111 to perform the other process.

When the image sharing apparatus 109 is instructed to perform the end process, the result of the determination process of step S602 causes control to proceed to step S611, in which the end process is performed.

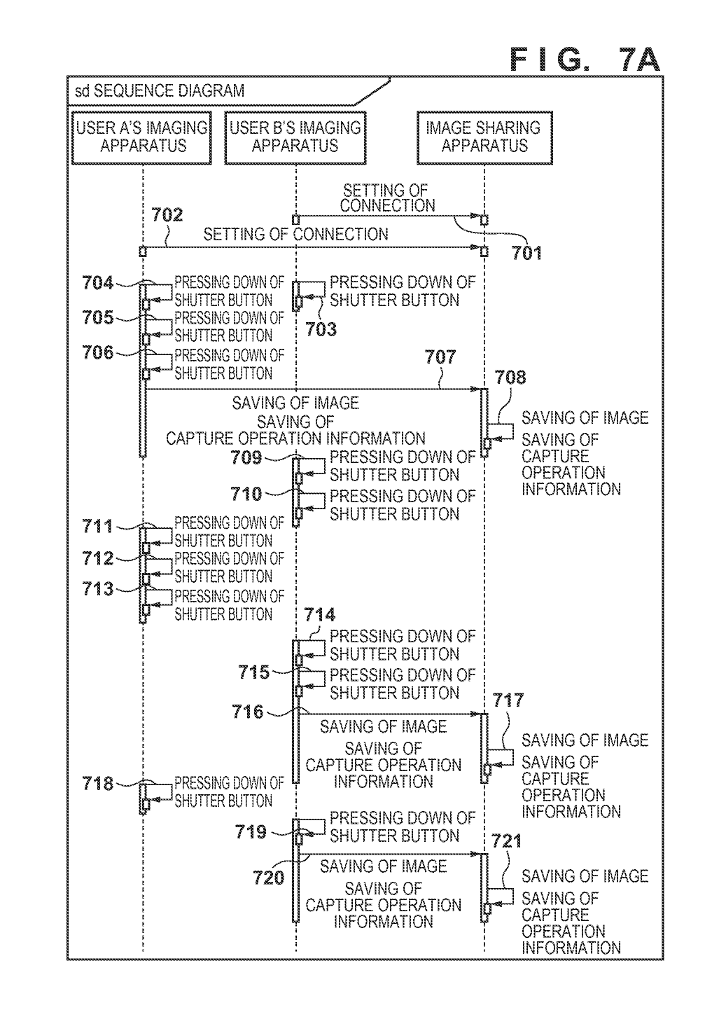

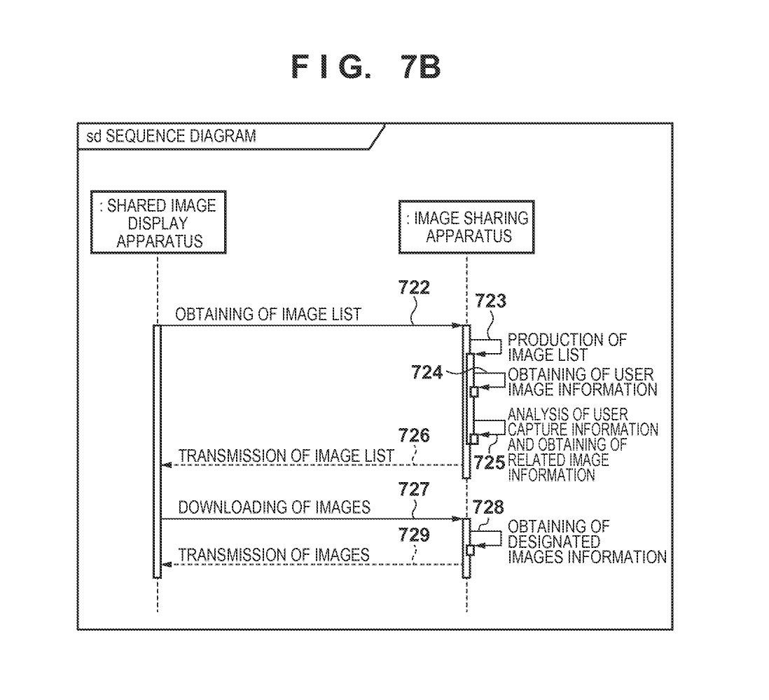

FIGS. 7A and 7B are diagrams showing communication sequences between the image sharing apparatus 109 of the first embodiment, and the imaging apparatus 101 and the shared image display apparatus 116. Reference characters 701 to 729 indicate events or processes on the sequences.

FIG. 7A shows a flow of the communication sequence between the image sharing apparatus 109 and the imaging apparatus 101. Here, in order to show a sequence in which a plurality of imaging apparatuses access an image sharing apparatus, a user A's imaging apparatus and a user B's imaging apparatus are shown in FIGS. 7A and 7B. Initially, in events 702 and 701, the imaging apparatuses of the users A and B are set to access the image sharing apparatus.

Next, each imaging apparatus performs a process, such as image capture etc. For example, the user A presses the shutter button down and saves captured images and capture operation information thereof, at events 704 to 706, 711 to 713, and 718, as described above with reference to FIG. 3. The user B presses the shutter button down and saves captured images and capture operation information thereof, at events 703, 709 and 710, 714 and 715, and 719.

At event 707, the user A instructs the image sharing apparatus to save images and capture operation information thereof. At events 716 and 720, the user B instructs the image sharing apparatus to save images and capture operation information thereof. In response to this communication, the image sharing apparatus saves the images of the users A and B to the storage unit of the image sharing apparatus at events 708, 717, and 721, as described about the processes of steps S606 and S609 of FIG. 6.

Next, FIG. 7B shows a flow of the communication sequence between the image sharing apparatus 109 and the shared image display apparatus 116. When the shared image display apparatus sends an image list obtaining instruction or request 722 to the image sharing apparatus, the image sharing apparatus performs an image list producing process 723. The image list producing process 723 roughly includes two processes 724 and 725. In the process 724, the image information of a user is obtained from the storage unit of the image sharing apparatus 109 based on the user information stored in the shared image display apparatus. In the process 725, the capture operation information of the user is analyzed to obtain image information relating to the user from shared images of other users. As a result of these processes, the image sharing apparatus produces an image list, and transmits the image list to the shared image display apparatus at event 726.

The shared image display apparatus also sends an image download instruction or request 727 to the image sharing apparatus. In response to this instruction, the image sharing apparatus obtains designated images from the storage unit at event 728, and transmits the images to the shared image display apparatus at event 729.

Next, the image list producing process of step S607 of FIG. 6 will be described in detail with reference to a flowchart shown in FIG. 8.

When instructed to perform the image list obtaining process, initially in step S801 the image sharing apparatus 109 obtains, from the storage unit 113, image information of a user who has sent communication data instructing to obtain a list of images (image information of a first imaging apparatus), based on the user information of the sender user (user information of the first imaging apparatus).

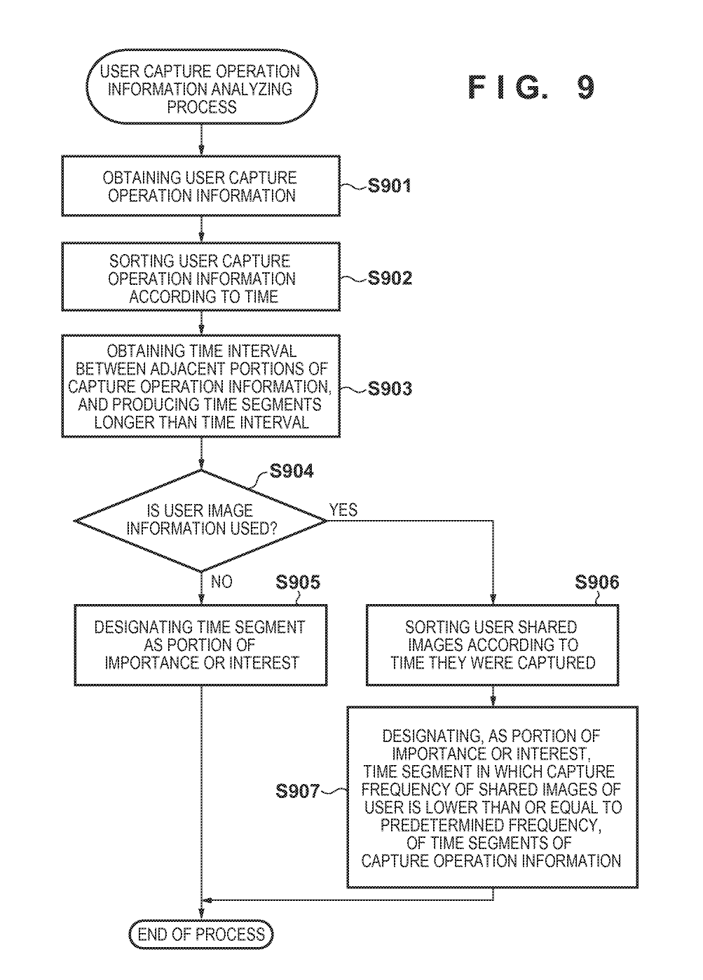

In step S802, the image sharing apparatus 109 analyzes the capture operation information of the user sending the communication data based on the user information of the user, to find out a portion (time segment) which is of importance or interest to the user. This process will be described in detail below with reference to FIG. 9.

In step S803, the image sharing apparatus 109 extracts, from the storage unit 113, information of shared images of other users (image information of imaging apparatuses other than the first imaging apparatus) corresponding to the portion (time segment) of importance or interest to the user which has been found out in step S802.

In step S804, the image sharing apparatus 109 produces an image list based on the image information of the user obtained in step S801 and the image information of shared images of other users obtained in step S803 corresponding to the portion of importance or interest to the user.

In step S805, the image sharing apparatus 109 transmits the produced image list to the apparatus which has sent the request, and ends the process.

Next, the process of analyzing the capture operation information of the user in step S802 of FIG. 8 will be described in detail with reference to the flowchart of FIG. 9.

In step S901, the image sharing apparatus 109 obtains the capture operation information of the user. In step S902, the image sharing apparatus 109 sorts the capture operation information of the user according to the time the operations were performed.

In step S903, the image sharing apparatus 109 obtains a time interval between each adjacent portion of the capture operation information, and produces a plurality of time segments having a predetermined length of time longer than the time interval.

In step S904, the image sharing apparatus 109 determines whether or not to use the image information of the user stored therein in order to analyze the capture operation information of the user. If the result of the determination in step S904 is negative (“NO”), control proceeds to step S905. On the other hand, if the result of the determination in step S904 is positive (“YES”), control proceeds to step S906.

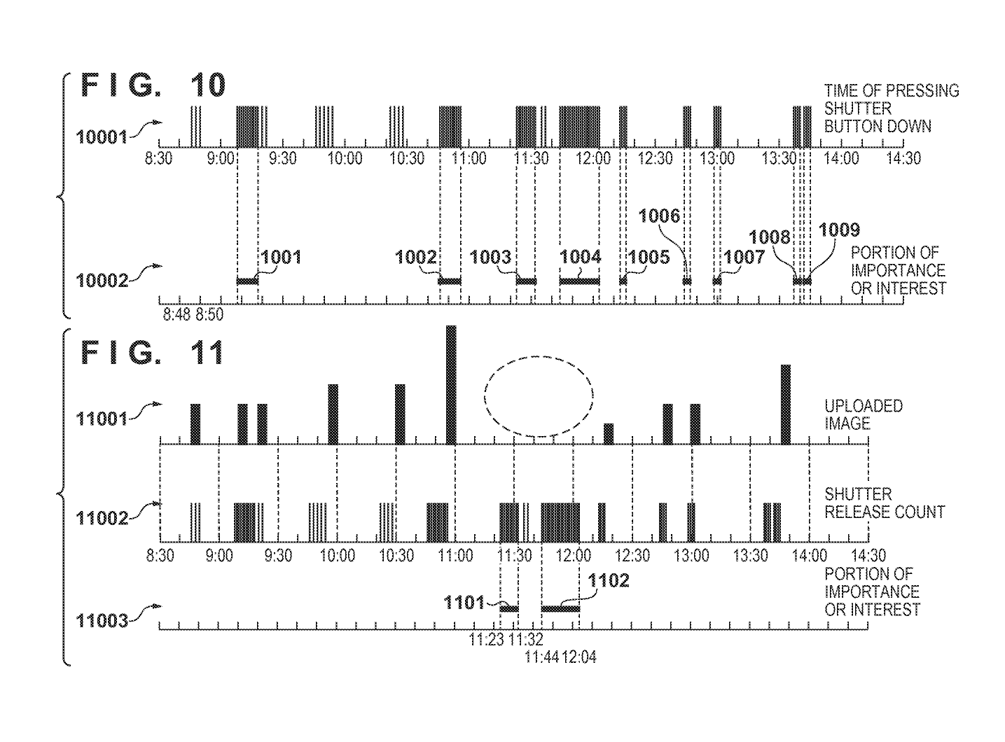

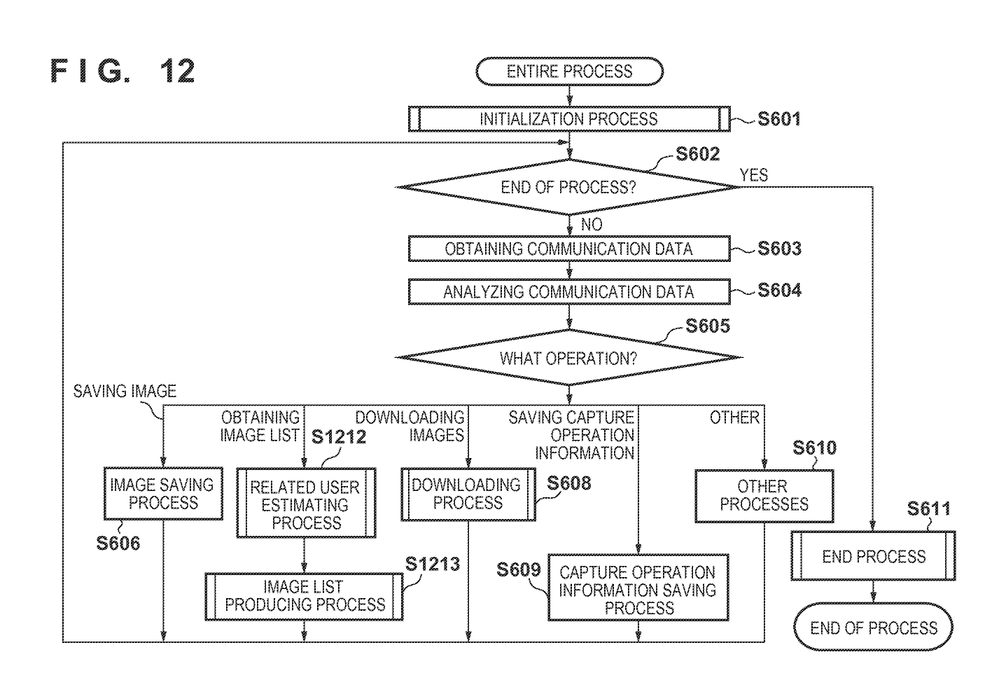

In step S905, the image sharing apparatus 109 designates a plurality of time segments as a portion of importance or interest to the user. A technique of determining which time segment is designated as a portion of importance or interest to the user will be described below with reference to FIGS. 10 and 11.

In step S906, the image sharing apparatus 109 sorts stored images of the user according to the time the images were captured. As a result, in step S907, the image sharing apparatus 109 designates, as a portion of importance or interest to the user, a time segment(s) (second time segment) in which the image capture frequency of the user is lower than or equal to a predetermined frequency, of time segments (first time segments) of the capture operation information. Thus, the processes of FIG. 9 are ended.

In this embodiment, the capture operation information contains the combination of a capture operation (“shutter button press operation”) and the time of occurrence of the capture operation. Therefore, a designated portion which is of importance or interest to the user may be a period of time which is of importance or interest to the user, that is obtained based on the capture operation information. However, the capture operation information is not limited to this. For example, if the capture operation information contains the combination of a capture operation (“shutter button press operation”) and the “place of occurrence” of the capture operation, a designated portion which is of importance or interest to the user may be a “place” which is of importance or interest to the user.

Here, FIG. 10 is a diagram showing an example capture operation information analyzing process which is performed only based on capture operation information.

As described above, in this embodiment, the imaging apparatus 101 saves, as capture operation information, the time the user pressed the shutter button down. When the imaging apparatus 101 instructs the image sharing apparatus 109 to store images, the imaging apparatus 101 transmits the capture operation information simultaneously along with the images, and the capture operation information and the images are then saved to the storage unit 113. The capture operation information of the user obtained in step S901 of FIG. 9 is indicated by a reference character 10001 in FIG. 10. Based on the capture operation information, a portion in which the user pressed the shutter button down at a high frequency (a portion in which the shutter button was pressed down at least a predetermined number of times per unit time) can be designated as a portion which is of importance or interest to the user, e.g., time segments 1001 to 1009 in the whole time 10002 of FIG. 10.

FIG. 11 is a diagram showing an example of the capture operation information analyzing process which is performed based on information about stored images of the user.

As described above, in this embodiment, the imaging apparatus 101 saves, as capture operation information, the time the user pressed the shutter button down. In this embodiment, when the imaging apparatus 101 instructs the image sharing apparatus 109 to store images, the imaging apparatus 101 transmits the capture operation information simultaneously along with the images, and the capture operation information and the images are then saved to the storage unit 113. The capture operation information of the user obtained in step S803 of FIG. 8 is indicated by a reference character 11001 in FIG. 11. The capture operation information of the user obtained in step S901 of FIG. 9 is indicated by a reference character 11002 in FIG. 11. Based on these pieces of information, it can be determined that a portion in which the user did not save an image to the image sharing apparatus 109 although the user pressed the shutter button down at a high frequency, is likely to be of importance or interest to the user (particularly in this case, the user may want images captured by others in the portion). For example, it can be inferred that the user failed to capture an image. Therefore, time segments 1101 and 1102 in the whole time 11003 of FIG. 11 can each be designated as a portion of importance or interest to the user.

As described above, in step S802 of FIG. 8, a portion of importance or interest to the user is found out as shown in FIGS. 10 and 11. Information of shared images of other users corresponding to the found portion of importance or interest to the user, is obtained from the storage unit 113 in step S803 of FIG. 8, and a list of the images is produced and transmitted to an apparatus (shared image display apparatus) which is a request sender, which then presents the image list to the user.

Thus, in this embodiment, if a user only uploads images captured by himself or herself and capture operation information thereof to an image sharing apparatus, the user is allowed to efficiently browse only one or ones that are of importance or interest to himself or herself, of images captured by other users.

### Second Embodiment

In this embodiment, an example will be described in which when images on a sharing site are narrowed down, based on camera operation information which is obtained when a user captures the images, before presenting a plurality of images (first embodiment), shared images of other users who tend to capture images similar to those captured by that user, are assigned higher priorities. Specifically, images on a sharing site are narrowed down by estimating a group to which the user belongs based on the camera operation information of the user, before presenting a plurality of images. Note that the configuration of the apparatuses of this embodiment is similar to that of the first embodiment and will not be described.

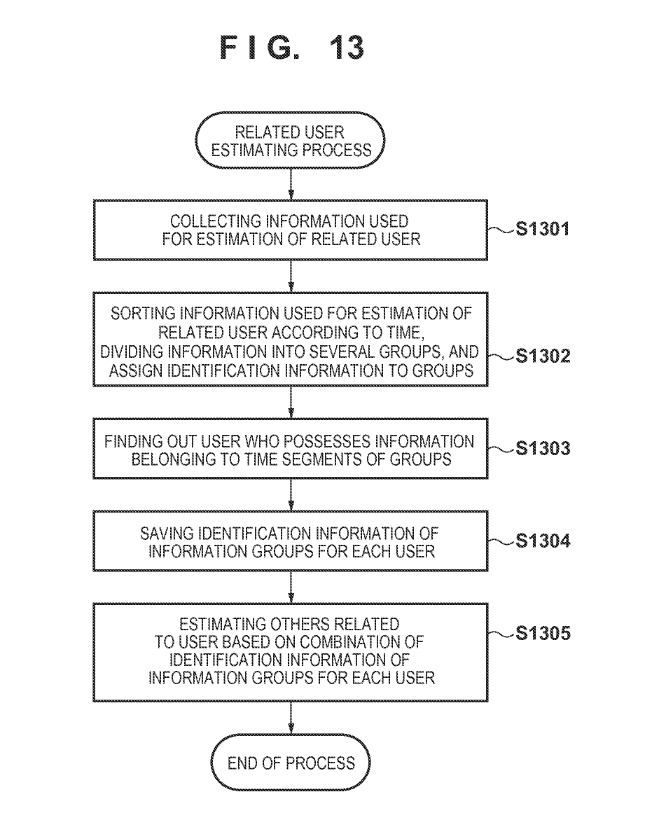

FIG. 12 is a flowchart showing steps of an entire process of an image sharing apparatus 109 according to the second embodiment. The flowchart of FIG. 12 includes a related user estimating process of step S1212 in addition to the processes of FIG. 6 of the first embodiment. In this embodiment, it is assumed that a user A captures images in a sports day.

The actuation of the image sharing apparatus 109 and the processes of steps S601 to S604 are similar to those of the first embodiment.

The user A checks captured images and uploads good ones thereof to a shared holder in order to use the images after returning home. When the user A uploads images from the imaging apparatus 101 to the image sharing apparatus 109, in step S605 it is determined based on the result of the analysis of transmitted data in step S604 that the user's operation is the image saving process from the imaging apparatus 101.

After capturing images in the sports day and returning home, the user A is about to check the images captured on that day using the shared image display apparatus 116. When the user A instructs the image sharing apparatus 109 to obtain an image list, control proceeds to the determination process of step S605 and then to step S1212.

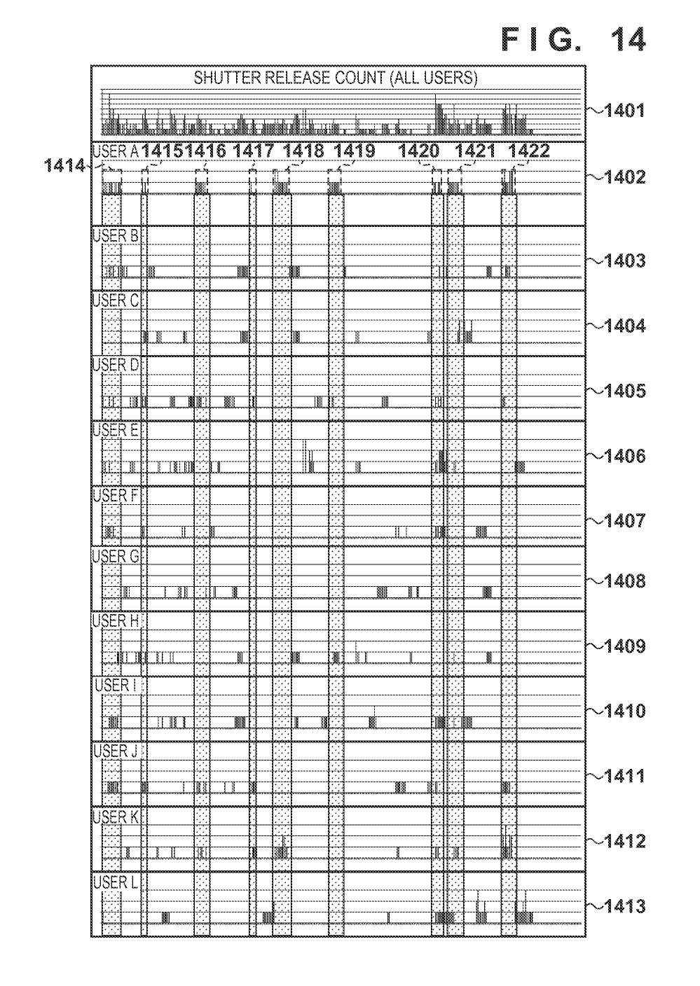

In step S1212, the image sharing apparatus 109 estimates a plurality of users who are related to the user A. The process of step S1212 is an additional process in this embodiment compared to the first embodiment. This process will be described in detail below with reference to FIGS. 13 and 14.

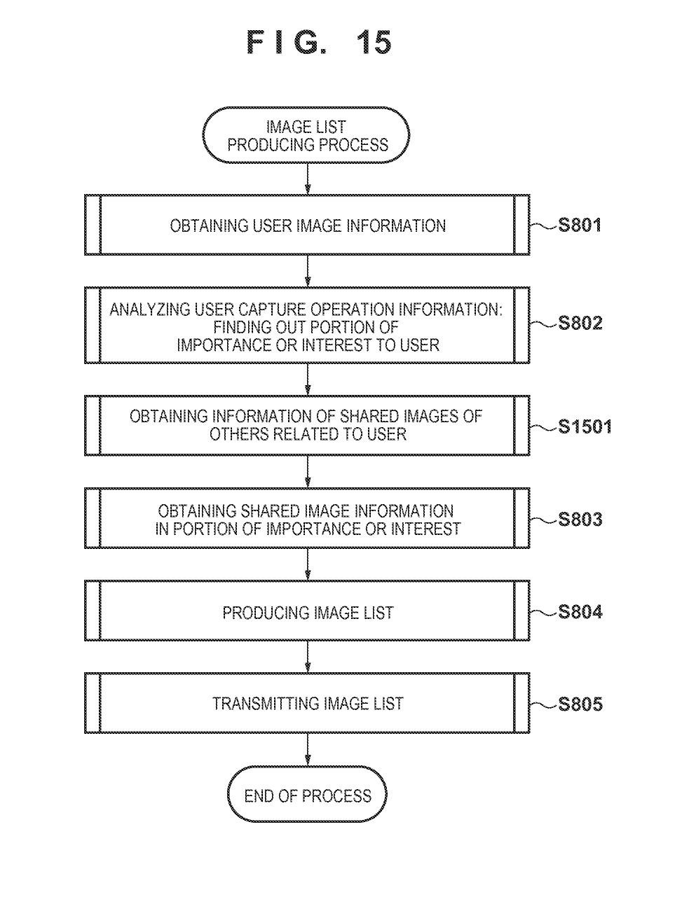

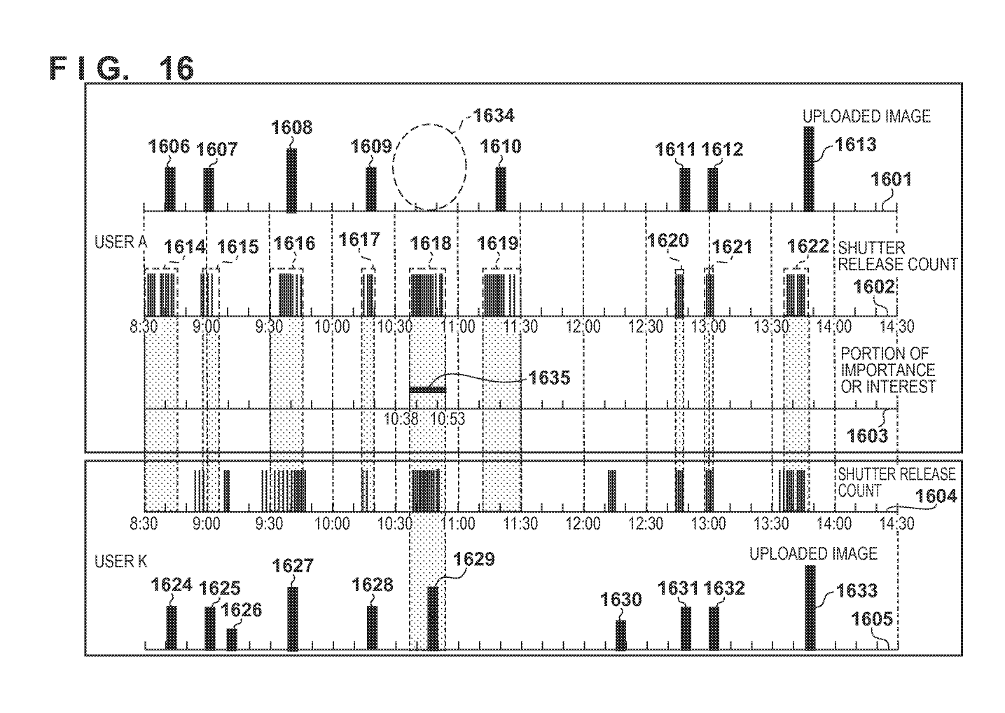

In step S1213, the image sharing apparatus 109 performs an image list producing process based on information about the related users estimated in step S1212. The process of step S1213 replaces the process of step S607 of the first embodiment. This process will be described in detail below with reference to FIGS. 15 and 16. The other processes are similar to those described with reference to FIG. 6.

The process of estimating related users which is performed by the image sharing apparatus 109 of the second embodiment will now be described in detail with reference to the flowchart of FIG. 13. Note that FIG. 14 is a diagram showing an example of the related user estimating process of the second embodiment using capture operation information.

Before obtaining an image list, in step S1301 the image sharing apparatus 109 collects information which is used to estimate related users. In this embodiment, in order to estimate related users, the capture operation information 115 of a plurality of users which is stored in the storage unit 113 of the image sharing apparatus 109 is used. For example, as shown in FIG. 14, it is assumed that a plurality of users A to L use the image sharing apparatus 109.

In step S1302, the image sharing apparatus 109 sorts the capture operation information of the user A according to time, and divides the capture operation information of the user A into several groups. These groups are assigned identification information. Here, as indicated by reference characters 1402 to 1413 in FIG. 14, the capture operation information of each of the users A to L is sorted according to time. The capture operation information of the user A is assumed to be divided into groups 1414 to 1422. Here, the numbers 1414 to 1422 are assumed to be identification information assigned to the groups. Note that a reference character 1401 indicates statistical information about the number of times all of the users A to L pressed the shutter button down.

In step S1303, the image sharing apparatus 109 tries to find out any other user who possesses capture operation information which belongs to any of the time segments of the groups 1414 to 1422. For example, for the group 1416 of FIG. 14, the image sharing apparatus 109 tries to find out any other user who possesses information belonging to the time segment of the group 1416. In this case, the users D, J, and K etc. are found out.

In step S1304, the image sharing apparatus 109 saves identification information of any one or ones containing capture operation information, of the time segments of the groups 1414 to 1422 of the capture operation information of the user A, for each of the other users. In FIG. 14, as a result of the process of step S1303, the groups 1416, 1417, 1418, 1420, 1421, and 1422 are saved for the user K, for example.

In step S1305, the image sharing apparatus 109 estimates a plurality of other users related to the user A based on the combination of identification information of groups of capture operation information for each user. In the example of FIG. 14, based on the identification information of the groups saved in step S1304, it is estimated that the user K is most related to the user A. In this embodiment, the number of pieces of identification information of groups saved in step S1304 is defined as the degree of relation. Here, only a user having the highest degree of relation may be designated as another user related to the user A, or alternatively, a threshold may be provided for the degree of relation, and all users who have a degree of relation higher than or equal to the threshold may be designated as a related user.

An image list producing process performed by the image sharing apparatus 109 of the second embodiment will now be described in detail with reference to a flowchart shown in FIG. 15. The process of FIG. 15 includes the process of step S1501 in addition to the processes of the first embodiment of FIG. 8. Note that FIG. 16 is a diagram for describing the image list producing process of the second embodiment. In FIG. 16, a reference character 1601 indicates shared images (uploaded images) of the user A, a reference character 1602 indicates the number of times the user A pressed the shutter button down (also referred to as a “shutter release count”) as capture operation information, and a reference character 1603 indicates portions which are of importance or interest to the user A. A reference character 1604 indicates the number of times the user K pressed the shutter button down (also referred to as a “shutter release count”), which is capture operation information of the user K, and a reference character 1605 indicates shared images (uploaded images) of the user K. Note that it is assumed that, as a result of the related user estimating process of step S1212 of FIG. 12 (FIG. 13 shows a detailed flow thereof), the user K is estimated to be related to the user A.

In FIG. 15, the processes of steps S801 and S802 are similar to those of the first embodiment. Initially, in step S801, based on the user information of a user which has sent communication data indicating an instruction to obtain an image list, the image sharing apparatus 109 obtains the image information of the user from the storage unit 113. As a result, information about uploaded images 1601 of the user A is obtained as shown in FIG. 16.

In step S802, the image sharing apparatus 109 analyzes the capture operation information of the user to find out a portion which is of importance or interest to the user. Initially, a series of shared images 1606 to 1613 (1601) of the user A of FIG. 16 are compared with a series of shutter release counts 1614 to 1622 (1602) as the capture operation information. As a result, it is found that the user A did not upload an image during a time segment 1634 although the user A pressed the shutter button down as indicated by the reference character 1618. As a result, a portion 1635 which is of importance or interest to the user A is found out.

Here, as described above, before this process, it is assumed that, in step S1212, the series of capture operation information (shutter release counts) 1604 of the user K is determined to be related to the series of capture operation information (shutter release counts) 1614 to 1622 (1601) of the user A of FIG. 16, and the user K is estimated to be related to the user A.

In step S1501 following step S802, the image sharing apparatus 109 obtains information about shared images of the related user estimated in step S1212. The information about shared images of the related user estimated corresponds to the uploaded images 1624 to 1633 (1605) of the user K of FIG. 16.

In step S803 following step S1501, the image sharing apparatus 109 obtains the shared images of the user K corresponding to the portion 1635 of FIG. 16 which is of importance or interest to the user A. Specifically, obtained are shared images 1629 which were captured by the user k during a time segment between 10:38 and 10:53 which is the portion 1635 of FIG. 16 which is of importance or interest to the user A.

In step S804, the image sharing apparatus 109 produces an image list based on the obtained images 1601 which have been uploaded by the user A and the shared images 1629 which were captured by the user K related to the user A during a time segment (1635) which is of importance or interest to the user A.

In step S805, the image sharing apparatus 109 transmits the produced image list to the requesting apparatus.

Thus, in this embodiment, if a user only uploads images captured by himself or herself along with capture operation information thereof to an image sharing apparatus, the user is allowed to efficiently browse one or ones which are of importance or interest to the user, of images which have been captured by other users who tend to capture images similar to those captured by that user. Although, in this embodiment, a user is estimated to tend to capture images similar to those captured by another user (i.e., have a similar image preference) based on camera operation information of the users, the present invention is not limited to this. For example, such estimation may be made using information about uploading of shared images of a user as information for user estimation, instead of the camera operation information of a user.

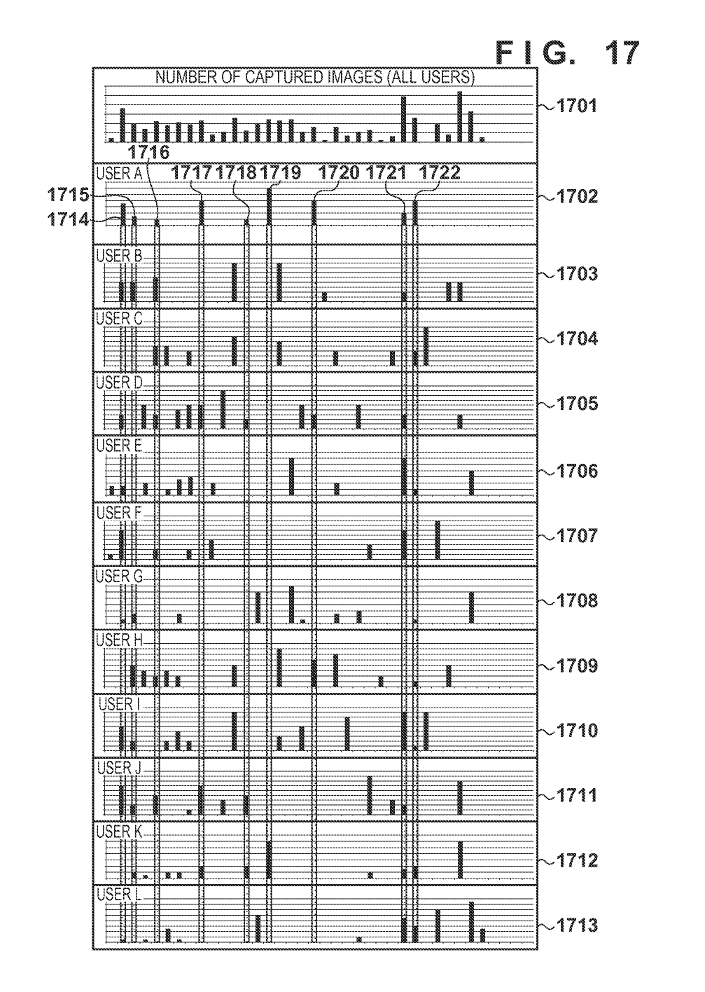

A related user estimating process according to the second embodiment based on the image uploading information will now be described with reference to FIGS. 13 and 17.

Before obtaining an image list, in step S1301 the image sharing apparatus 109 collects information which is to be used to estimate a user. In this embodiment, in order to estimate a related user, the image information 114 of shared images of a plurality of users, which is stored in the storage unit 113 of the image sharing apparatus 109, is used. For example, as shown in FIG. 17, a plurality of users A to L are assumed to use the image sharing apparatus 109.

Next, in step S1302, the image sharing apparatus 109 sorts information (information of shared images) which is used to estimate a user related to the user A according to time, and divides the information into several groups. Thereafter, the groups are assigned identification information. Here, for a user A of users 1702 to 1713 of FIG. 17, information of shared images (uploaded images) of the user A is divided into groups 1714 to 1722. Here, the numbers 1714 to 1722 are identification information assigned to the groups.

In step S1303, the image sharing apparatus 109 tries to find out any other user who has uploaded shared images captured during any of the time segments of the groups 1714 to 1722. For example, for the group 1718 of FIG. 17, the image sharing apparatus 109 tries to find out any other user who has uploaded shared images captured during the time segment of the group 1718. In this case, the users D, J, and K etc. are found out.

In step S1304, for each of users other than the user A, the image sharing apparatus 109 saves identification information of any one or ones containing shared images captured by that user other than the user A, of the time segments of the groups 1714 to 1722 of the shared image information of the user A. In the example of FIG. 17, as a result of the process of step S1303, the groups 1715, 1717, 1718, 1719, 1721, and 1722 are saved for the user K.

In step S1305, the image sharing apparatus 109 estimates a plurality of other users related to the user A based on the combination of identification information of groups of shared image information for each user. In the example of FIG. 17, based on the identification information of the groups saved in step S1304, it is estimated that the user K is most related to the user A. In this embodiment, the number of pieces of identification information of groups saved in step S1304 is defined as the degree of relation.

As described above, the user K may be estimated to be related to the user A using the information of uploading of shared images of a user as information for user estimation, instead of the camera operation information of a user.

Although, in the above embodiments, the capture operation information 107 contains the combination of a capture operation (=“the pressing down of the shutter button”) and the time the shutter button was pressed down, the present invention is not limited to this.

For example, as shown in Table 502 of FIG. 5, one piece of capture operation information may be saved in association with two or more times. The capture operation is not limited to the pressing down of the shutter button. For example, the combination of an operation of pressing the shutter button halfway down and a period of time during which the operation is continued, the combination of an operation of keeping the camera in a horizontal position, which is detected by an orientation sensor, and a period of time during which the operation is continued, etc., may be used. Alternatively, the combination of an operation of looking into the viewfinder, which is detected by a proximity sensor, and a period of time during which the operation is continued, etc., may be used.

In this embodiment, the capture operation information of a user is saved to the storage unit 104 as the capture operation information 107 which is obtained by the capture operation information obtaining unit 105 included in the imaging apparatus 101 of FIG. 1. The present invention is not limited to this. For example, an apparatus for recording GPS information per unit time may be carried while capturing images in order to add the GPS information to images. The GPS information may be added to captured images later, and another apparatus for obtaining the capture operation information 107 may be provided. In this case, the capture operation information 107 may be received from another capture operation information obtaining apparatus at the same time when the communication unit 106 uploads images, and may be uploaded to the image sharing apparatus 109 along with image information.

In the above embodiments, in steps S308 and step S309 of FIG. 3, capture operation information and images are simultaneously uploaded as an example. The present invention is not limited to this. Images and capture operation information may be uploaded at different timings. For example, although images may be uploaded while being captured, capture operation information may be uploaded after the user returns home. For example, when the user checks shared images at home, the user may upload capture operation information from the shared image display apparatus 116. Alternatively, only capture operation information may always be uploaded. The start and end of uploading of capture operation information may be explicitly designated. In this case, in order to reduce the effort to upload images, the user may check and upload images after returning home.

Alternatively, capture operation information may be uploaded directly from an apparatus (a capture operation information obtaining apparatus etc.) other than the imaging apparatus 101 to the image sharing apparatus 109.

In the above embodiments, the example process of estimating a related user has been described with reference to FIG. 13. The present invention is not limited to this. For example, a related user may be estimated using commonly used collaborative filtering. Specifically, correlation analysis may be performed on information about image capture performed by the user A which is used to estimate a related user and the same information corresponding to another user. A user which is determined to have a correlation value greater than or equal to a predetermined value may be estimated to be a related user. A user having a high level of correlation may be assumed to have a similar image preference, and may be estimated to be a “related user.” A user having a more similar image preference seems to be more likely to have images which the user A would have desired to capture.

According to the present invention, if a user captures images in a usual way and only uploads images which the user wants to share with others and camera operation information to a sharing site, then when the user checks images on the sharing site, the user can efficiently browse only one or ones of shared images of others that are related to the user.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-057302 filed on Mar. 19, 2013, which is hereby incorporated by reference herein in its entirety.

What is claimed is:

1. An image processing apparatus comprising:
a storage unit configured to store user information of an imaging apparatus, image information containing an image or images captured by the imaging apparatus, and operation information of the imaging apparatus during image capture, in association with each other;
an obtaining unit configured to obtain operation information corresponding to user information of a first imaging apparatus when receiving the user information of the first imaging apparatus;
an analysis unit configured to analyze at least one time segment based on the operation information; and
an extraction unit configured to extract image information corresponding to the at least one time segment from image information of an imaging apparatus or apparatuses other than the first imaging apparatus.

2. The image processing apparatus according to claim 1, wherein
the analysis unit analyzes at least one time segment obtained by dividing a period of time during which a capture operation has been performed, using the operation information, in order to find out at least one time segment which is of importance or interest to the user.

3. The image processing apparatus according to claim 1, wherein
the analysis unit obtains at least one first time segment obtained by dividing a period of time during which a capture operation has been performed, using the operation information,
the analysis unit obtains at least one second time segment during which the capture frequency of images captured by the user is lower than or equal to a predetermined frequency, of the at least one first time segment, using the image information, and
the analysis unit analyzes the at least one second time segment in order to find out at least one time segment which is of importance or interest to the user.

4. The image processing apparatus according to claim 1, further comprising:
an estimation unit configured to estimate a user of one of the other imaging apparatuses which is related to the first imaging apparatus, based on operation information of another user or users stored in the storage unit,
wherein
the extraction unit extracts image information corresponding to the at least one time segment from image information of the other imaging apparatus corresponding to the user estimated by the estimation unit.

5. The image processing apparatus according to claim 1, wherein
the operation information contains a user's operation and the time of occurrence of the user's operation.

6. The image processing apparatus according to claim 5, wherein
the user's operation is pressing down of a shutter button.

7. The image processing apparatus according to claim 1, wherein
the operation information contains a user's operation and a duration of the user's operation.

8. The image processing apparatus according to claim 7, wherein
the user's operation is pressing halfway down of a shutter button.

9. The image processing apparatus according to claim 7, wherein
the user's operation is keeping an imaging apparatus in a horizontal position.

10. The image processing apparatus according to claim 1, wherein
the operation information is information about turning on or off of an imaging apparatus or information about an operation on a viewfinder of an imaging apparatus.

11. A method for controlling an image processing apparatus, comprising:
a storing step of storing user information of an imaging apparatus, image information containing an image or images captured by the imaging apparatus, and operation information of the imaging apparatus during image capture, in association with each other;
an obtaining step of obtaining operation information corresponding to user information of a first imaging apparatus when receiving the user information of the first imaging apparatus;
an analyzing step of analyzing at least one time segment based on the operation information; and
an extracting step of extracting image information corresponding to the at least one time segment from image information of an imaging apparatus or apparatuses other than the first imaging apparatus.

12. A non-transitory computer-readable storage medium storing a computer program which, when executed on a computer, causes the computer to execute the steps of the method according to claim 11.
